(19) United States
(12) Patent Application Publication
(10) Pub. No.: US 2021/0159556 A1
(43) Pub. Date: May 27, 2021

(54) COOLING DEVICE AND BATTERY DEVICE INCLUDING THE SAME

(71) Applicant: Samsung Electronics Co., Ltd., Suwon-si (KR)

(72) Inventors: Ji-Young JEONG, Hwaseong-si (KR); Jeongsik KO, Hanam-si (KR); Daebong JUNG, Seongnam-si (KR)

(73) Assignee: Samsung Electronics Co., Ltd., Suwon-si (KR)

(21) Appl. No.: 16/844,111

(22) Filed: Apr. 9, 2020

(30) Foreign Application Priority Data
Nov. 26, 2019 (KR) 10-2019-0153471

(51) Int. Cl. H01M 10/613; H01M 10/625; H01M 10/647; H01M 10/6552; H01M 10/6556; H01M 10/6568; H01M 2/10

(52) U.S. Cl. CPC H01M 10/613; H01M 10/625; H01M 10/647; H01M 2/1016; H01M 10/6556; H01M 10/6568; H01M 10/6552

(57) ABSTRACT

A cooling device includes a direct liquid cooling medium and a plurality of heat transferrers. The direct liquid cooling medium is configured to directly contact and absorb heat from a plurality of battery modules included in a battery pack. The plurality of heat transferrers, each respectively disposed between the battery modules, is configured to absorb heat generated in a portion of each of the battery modules through an internal cooling medium.

### CROSS-REFERENCE TO RELATED APPLICATIONS

This application claims the benefit under 35 USC § 119(a) of Korean Patent Application No. 10-2019-0153471 filed on Nov. 26, 2019, in the Korean Intellectual Property Office, the entire disclosure of which is incorporated herein by reference for all purposes.

### BACKGROUND

### 1. Field

The following description relates to a cooling device and a battery device, including the cooling device.

### 2. Description of Related Art

A battery may include a high-voltage battery pack including a plurality of battery modules. The battery pack may generate heat while being charged or discharged. The heat generated in the battery pack may degrade the performance of the battery or shorten the life of the battery.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a cooling device includes a direct liquid cooling medium and a plurality of heat transferrers. The direct liquid cooling medium is configured to directly contact and absorb heat from a plurality of battery modules included in a battery pack. The plurality of heat transferrers, each respectively disposed between the battery modules, is configured to absorb heat generated in a portion of each of the battery modules through an internal cooling medium.

The direct liquid cooling medium may be further configured to absorb heat from the battery modules by directly contacting another portion of each of the battery modules, excluding a portion of each of the battery modules in which electrical elements are most densely concentrated.

The electrical elements may include at least one of a busbar configured to electrically connect the battery modules and a battery module tap.

The direct liquid cooling medium may be further configured to circulate through a cooling passage. Another portion of each of the battery modules and the heat transferrers may be disposed in the cooling passage.

The direct liquid cooling medium may be disposed in a closed space.

The direct liquid cooling medium may have electrical conductivity that is less than or equal to a threshold value required for electrosynthesis to occur.

The heat transferrers may be further configured to receive heat of the battery modules through the direct liquid cooling medium or absorb heat directly from the battery modules.

Each of the heat transferrers, serially disposed, may have a different surface area in a flow direction of the direct liquid cooling medium.

Each subsequently disposed heat transferrer of the heat transferrers may have a larger surface area than precedingly disposed heat transferrer in the flow direction of the direct liquid cooling medium.

The heat transferrers may be offsetly disposed in a rear portion of each of the battery modules in the flow direction of the direct liquid cooling medium.

The heat transferrers may have thicknesses determined based on a heat-generating property of the battery modules.

The thicknesses of the heat transferrers corresponding to a most heat-generating portion of the battery modules may be less than the thicknesses of the heat transferrers corresponding to other portions of the battery modules.

The cooling device may further include a cooling passage configured to come into contact with the heat transferrers and dissipate heat through an internal indirect liquid cooling medium.

The heat transferrers may include the internal cooling medium configured to absorb or dissipate heat through a phase change in a closed space.

Each of the heat transferrers may be a heat pipe.

The internal cooling medium may be configured to transfer heat through a capillary or convection process in a closed space of each of the heat transferrers.

In another general aspect, a battery device includes a battery pack including a plurality of battery modules, a direct liquid cooling medium, and a plurality of heat transferrers. The direct liquid cooling medium is configured to directly contact and absorb heat from the battery modules. The plurality of heat transferrers, each respectively disposed between the battery modules, is configured to absorb heat generated in a portion of each of the battery modules through an internal cooling medium.

The direct liquid cooling medium may be further configured to absorb heat from the battery modules by directly contacting another portion of each of the battery modules, excluding a portion of each of the battery modules in which electrical elements are most densely concentrated.

The heat transferrers may be further configured to absorb heat of the battery modules through the direct liquid cooling medium or directly from the battery modules.

In another general aspect, a battery device includes a housing comprising a first compartment and a second compartment, a plurality of battery modules, and a plurality of heat transferrers. The first compartment includes a first liquid cooling medium and the second compartment includes a second liquid cooling medium. A portion of each of the plurality of battery modules extends from the first compartment. The plurality of heat transferrers, each respectively disposed between the battery modules, is configured to extend from the first compartment into the second compartment.

Each of the plurality of heat transferrers may absorb heat generated by the battery modules through an internal cooling medium.

Another portion of each of the plurality of battery modules may extend from the housing.

Other features and aspects will be apparent from the following detailed description, the drawings, and the claims.

### BRIEF DESCRIPTION OF THE DRAWINGS

FIG. 1 illustrates an example of a battery device, according to one or more embodiments.

FIG. 2 illustrates an example of an indirect liquid cooling medium use, according to one or more embodiments.

FIGS. 3 through 5 illustrate examples of a heat transferrer, according to one or more embodiments.

FIG. 6 illustrates an example of a vehicle, according to one or more embodiments.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Also, in the description of example embodiments, detailed description of structures or functions that are thereby known after an understanding of the disclosure of the present application may be omitted in some descriptions when it is deemed that such some descriptions may cause ambiguous interpretation of the example embodiments.

Hereinafter, examples will be described in detail with reference to the accompanying drawings, and like reference numerals in the drawings refer to like elements throughout.

There is a desire for a cooling device that may maintain a constant temperature of a battery for continued use and transfer generated heat to outside.

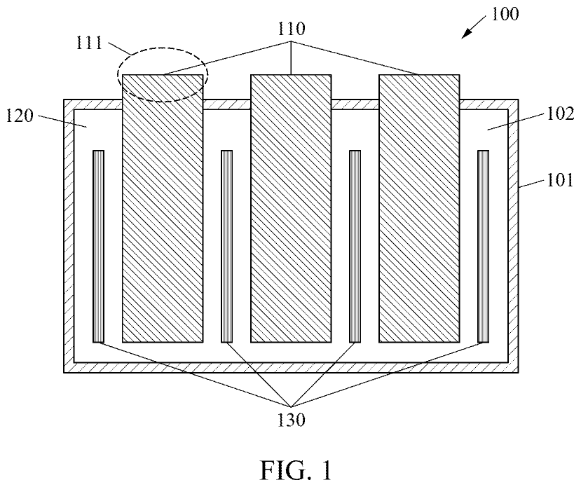

FIG. 1 illustrates an example of a battery device.

Referring to FIG. 1, a battery device 100 includes a battery pack having a housing 101, a direct liquid cooling medium 120, and a plurality of heat transferrers 130. In the non-limiting example of FIG. 1, three battery modules and four heat transferrers are illustrated as being included in the battery device 100 for the convenience of description. However, examples are not limited to the illustrated example, and various numbers of battery modules and heat transferrers may be included in the battery device 100.

The battery pack may supply power to a device in which the battery device 100 is provided or mounted, for example in, or representative of, an electric vehicle or a hybrid vehicle. The battery pack includes a plurality of battery modules 110, each including a plurality of battery cells. An upper end portion 111 of each of the battery modules 110 may be a portion in which electrical elements are most densely concentrated. The electrical elements may include at least one of a busbar configured to electrically connect battery modules included in a battery pack or a tap of a battery module. The tap may be a positive (+) terminal or a negative (−) terminal of each battery module, for example, through which power stored in a battery module may be output or the power may be input and stored in the battery module. The busbar may connect taps of neighboring battery modules such that the battery modules are electrically connected to one another. Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

The direct liquid cooling medium 120, disposed in the housing 101, may absorb heat from the battery modules 110 by being in direct contact with the battery modules 110. The direct liquid cooling medium 120 may absorb heat from each of the battery modules 110 by directly contacting a remaining portion of each of the battery modules 110 from which the upper end portion 111, extending out of or beyond the housing 101, in which the electrical elements are most densely concentrated is excluded. Compared to a gas cooling medium, the direct liquid cooling medium 120 may store a higher amount of specific heat per volume and have a higher heat conductivity enabling a fast heat exchange and may thus be effective in cooling.

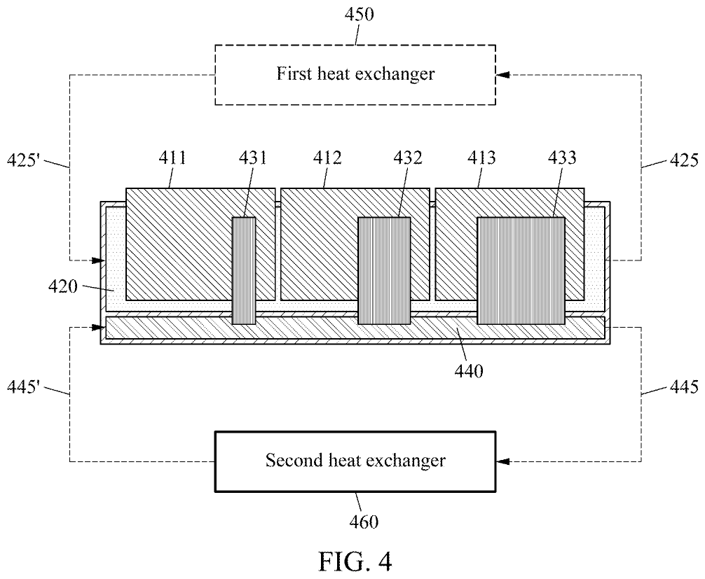

For example, the direct liquid cooling medium 120 may be contained in a closed space, for example, a closed water or liquid tank. In this example, at least a portion of the battery modules 110 and the heat transferrers 130 may be present in the closed space, e.g., first compartment 102. For another example, the direct liquid cooling medium 120 may circulate through a cooling passage. In this example, at least a portion of the battery modules 110 and the heat transferrers 130 may be present in the cooling passage, which will be described in greater detail with reference to FIG. 4. For still another example, the direct liquid cooling medium 120 may have an electrical conductivity that is less than or equal to a threshold value. In this example, even when the entire end portions of the battery modules 110 are immersed in the direct liquid cooling medium 120, an electrosynthesis may not occur.

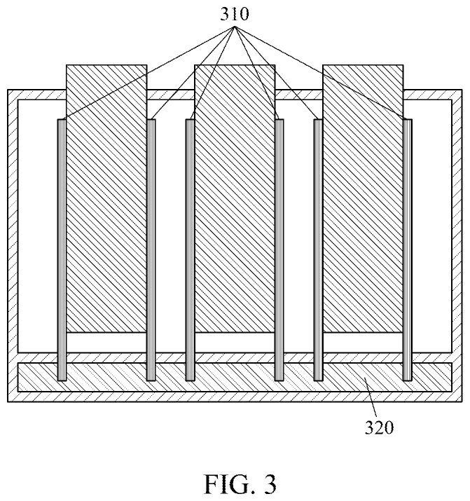

The heat transferrers 130 may be disposed between the battery modules 110, and absorb heat generated in at least a portion of each of the battery modules 110 through an internal cooling medium. That is, each of the battery modules 110 is disposed between neighboring heat transferers of the heat transferrers 130. For example, each of the heat transferrers 130 may receive the heat of a battery module that is not in direct contact with a corresponding heat transferrer through the direct liquid cooling medium 120. Alternatively, each of the heat transferrers 130 may absorb heat directly from a corresponding battery module by directly contacting the battery module, which will be described in detail with reference to FIG. 3.

Each of the heat transferrers 130 includes the internal cooling medium configured to absorb or release heat through a phase change in the closed space. The internal cooling medium may be a working fluid that transfers heat through a capillary phenomenon in the closed space of each of the heat transferrers 130. In addition, the internal cooling medium may transfer heat through a convection phenomenon in the closed space of each of the heat transferrers 130. Each of the heat transferrers 130 may be a heat pipe, for example.

The direct liquid cooling medium 120 and the heat transferrers 130 for cooling the battery pack may be collectively referred to as a cooling device.

According to an example, a more direct and effective cooling of the battery modules 110 may be provided using a liquid cooling medium that directly contacts the battery modules 110, rather than by cooling the battery modules 110 using a gas cooling medium or by bringing a cooling passage including a liquid cooling medium into direct contact with the battery modules 110. In addition, a battery temperature may be evenly distributed and prevent a thermal runaway in case of emergency by arranging the physical structures of the heat transferrers 130 between the battery modules 110.

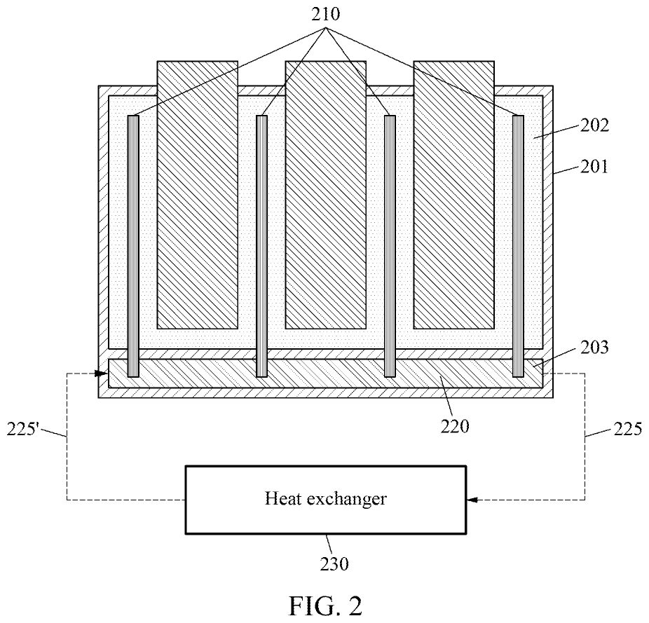

FIG. 2 illustrates an example of additional use of an indirect liquid cooling medium.

Referring to FIG. 2, an indirect liquid cooling medium 220 may be additionally used to cool a plurality of battery modules. In an example, the battery device includes battery modules disposed in housing 201, and the housing 201 may include a first compartment 202 and a second compartment 203. The direct liquid cooling medium may be disposed in the first compartment 202 and the indirect liquid cooling medium 220 may be disposed in the second compartment 203. The indirect liquid cooling medium 220 may absorb heat by contacting a portion of a plurality of heat transferrers 210 and release the heat using a heat exchanger 230 through a cooling passage 225 to dissipate the heat absorbed by the heat transferrers 210. The indirect liquid cooling medium 220, cooled by releasing the heat, may circulate from the heat exchanger 230 to the second compartment 230 through the return cooling passage 225′.

The heat exchanger 230 may cool the indirect liquid cooling medium 220 that absorbs the heat from the heat transferrers 210, and thus allow the indirect liquid cooling medium 220 to continuously absorb heat from the heat transferrers 210.

The indirect liquid cooling medium 220 may receive heat generated from the battery modules through the heat transferrers 210 without directly contacting the battery modules. Thus, such a liquid cooling medium is referred to as an indirect liquid cooling medium herein, for example, the indirect liquid cooling medium 220, as illustrated. The indirect liquid cooling medium 220 and the heat exchanger 230 may be used by incorporating a cooling device that is provided in a general type of an electric vehicle, and the like, and it is thus possible to minimize additional devices that are needed to implement the cooling device described herein.

FIGS. 3 through 5 illustrate examples of a heat transferrer.

Referring to FIG. 3, a plurality of heat transferrers 310 may be in contact with a surface of a plurality of battery modules. That is, the heat transferrers 310 may be disposed on both sides of each of the battery modules, as illustrated in FIG. 3. As the heat transferrers 310 are in direct contact with the surface of the battery modules, they may stably support the battery modules and apply appropriate pressure to the battery modules to maintain performance. Although an indirect liquid cooling medium 320 is illustrated in FIG. 3 for the convenience of description, the indirect liquid cooling medium 320 may not be used. For example, the heat transferrers 310 may directly contact the battery modules without the indirect liquid cooling medium 320 being used.

Referring to FIG. 4, a plurality of heat transferrers 431, 432, and 433 corresponding to a plurality of battery modules 411, 412, and 413, respectively, may be provided in different shapes. FIGS. 1 through 3 illustrate a battery device viewed from the front, while FIG. 4 illustrates a battery device viewed from the side.

A direct liquid cooling medium 420 that comes into direct contact with the battery modules 411, 412, and 413 may absorb heat directly from the battery modules 411, 412, and 413 by circulating through a first cooling passage 425 and release the heat in a first heat exchanger 450. The direct liquid cooling medium 420 may continuously circulate through the first cooling passage 425, the first heat exchanger 450, and the return first cooling passage 425′. The direct liquid cooling medium 420 that is cooled by releasing the heat in the first heat exchanger 450 may pass or circulate through the first battery module 411, the second battery module 412, and the third battery module 413, in a sequential order. The direct liquid cooling medium 420 may absorb heat from a battery module that is in contact while the direct liquid cooling medium 420 is circulating, and thus the temperature of the direct liquid cooling medium 420 may gradually increase. Thus, the effect of the direct liquid cooling medium 420 on the third battery module 413 may be less than the effect of the direct liquid cooling medium 420 on the first battery module 411 because the first battery module 411 is disposed of heat before the third battery module 413 in the flow direction of the direct liquid cooling medium 420. To compensate for this decreasing effect, the heat transferrers 431, 432, and 433 may be provided in different shapes.

The heat transferrers 431, 432, and 433 may be disposed to respectively correspond to the battery modules 411, 412, and 413 that are disposed in series in the flow direction in which the direct liquid cooling medium 420 flows, and may have different sizes of areas. For example, as illustrated, the heat transferrers 431, 432, and 433 may have gradually increasing surface area sizes in the flow direction, with the one disposed last in the flow direction having the largest surface area and the one disposed first in the flow direction having a smallest surface area. A heat transferrer with a relatively larger surface area may have a greater cooling effect, and thus a battery module receiving a less cooling effect from the direct liquid cooling medium 420 may be designed to have a corresponding heat transferrer with a relatively larger surface area. Thus, it is possible to have the same cooling effect on all battery modules. Although the heat transferrers 431, 432, and 433 are illustrated in FIG. 4 as having the same height but different widths based on the different surface areas, examples are not limited to the illustrated example. For example, any same or different shapes that may allow the surface areas to be larger in a serial order in the flow direction of the direct liquid cooling medium 420 may be applied without restriction.

In addition, respective heat transferrers may be disposed based on cooling effect of the direct liquid cooling medium 420 on a corresponding single battery module. Even in the single battery module, the cooling effect may vary based on the flow direction of the direct liquid cooling medium 420. For example, a rear portion of the battery module with which the direct liquid cooling medium 420 lastly comes into contact may have a less cooling effect than a front portion of the battery module with which the direct liquid cooling medium 420 firstly comes into contact. To offset such a deviation in the cooling effect, the heat transferrer may be disposed in the rear portion of the battery module in the flow direction. In the example of FIG. 4, based on a flow direction in which the direct liquid cooling medium 420 flows from left to right, the heat transferrers 431, 432, and 433 may be disposed on respective right sides of the battery modules 411, 412, and 413.

In the example of FIG. 4, an indirect liquid cooling medium 440 may be additionally used. The indirect liquid cooling medium 440 may be cooled in a second heat exchanger 460 by circulating through a second cooling passage 445. The second cooling passage 445 and the second heat exchanger 460 may be distinguishable from the first cooling passage 425 and the first heat exchanger 450, respectively. According to an example, the first heat exchanger 450 may be omitted. In such an example, the direct liquid cooling medium 420 may only circulate through the second cooling passage 445, the second heat exchanger 460 and the return second cooling passage 445′.

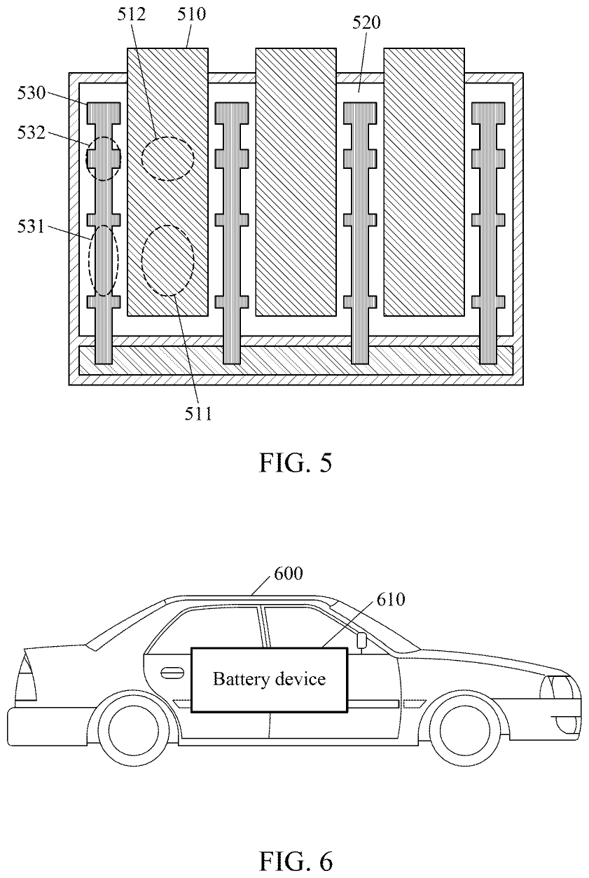

Referring to FIG. 5, a plurality of heat transferrers may have a thickness determined based on a heat-generating property of a battery module. The heat-generating property may vary depending on a type, shape, and the like of the battery module. The heat-generating property may include a location at which heat is generated, an amount of heat generated, and the like. That is, a point at which a chemical reaction occurs may vary for each battery module, and thus there may be a portion in which heat is generated the most even in the same battery module. In the example of FIG. 5, it is assumed for the convenience of the description that more heat is generated in a lower portion 511 of a battery module 510 than an upper portion 512 of the battery module 510.

As described above, a cooling effect may be significantly realized when a direct liquid cooling medium 520 directly contacts the battery module 510. Thus the cooling effect may be more significant when the direct liquid cooling medium 520 contacts more of the lower portion 511 where heat is generated in the battery module 510. For example, when a heat transferrer 530 is relatively thicker in thickness, a passage through which the direct liquid cooling medium 520 passes may be narrower accordingly, an amount of the direct liquid cooling medium 520 that comes into contact with the battery module 510 may be reduced, and thus, the cooling effect of the direct liquid cooling medium 520 may be lessened accordingly. Thus, a portion 531 of the heat transferrer 530 corresponding to the lower portion 511 of the battery module 510 may be thinner in thickness than another portion 532 of the heat transferrer 530 such that a larger amount of the direct liquid cooling medium 520 comes into contact with the lower portion 511 of the battery module 510.

Alternatively, the heat transferrer 530 may be thin in thickness, but be thicker in some other portions thereof. For example, a portion of the heat transferrer 530 that is relatively thick in thickness may be disposed on upper portions thereof and taper downwards towards lower portions such that a larger amount of the direct liquid cooling medium 520 comes into contact with the lower portion 511 of the battery module 510 which may have more generated heat than the upper portion 512 of the battery module 510.

FIG. 6 illustrates an example of a vehicle, according to one or more examples.

Referring to FIG. 6, a vehicle 600 includes a battery device 610. The vehicle 600 may be powered by a battery pack included in the battery device 610. The vehicle 600 may be an electric vehicle or a hybrid vehicle, for example.

The battery device 610 may include the battery pack, a direct liquid cooling medium, and a plurality of heat transferrers. According to an example, the battery device 610 may further include a battery management system (BMS) to monitor whether there is an abnormality in the battery pack and control the battery pack not to be over-charged or over-discharged. In addition, in a non-limiting example, when a temperature of the battery pack is greater than a first temperature, for example, 40° C., or is less than a second temperature, for example, −10° C., the BMS may perform heat control for the battery pack through a cooling device described above. Further, the BMS may perform cell balancing such that respective charging states of battery cells in the battery pack are balanced.

For a more detailed description, reference may be made to what has been described above with reference to FIGS. 1 through 5.

The battery device 100, the heat transferrers 130, 210, 310, and 530, the heat exchanger 230, the battery modules 411, 412, 413, and 510, the first heat exchanger 450, the second heat exchanger 460, the cooling device, the battery device, and other apparatuses, devices, units, modules, and components described herein with respect to FIGS. 1-6 are implemented by hardware components. Examples of further hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A cooling device, comprising:
a configuration of a direct liquid cooling medium in a battery pack directly contacting and absorbing heat from a plurality of battery modules included in the battery pack; and
a plurality of heat transferrers, each respectively disposed between the battery modules, configured to absorb heat generated in a portion of each of the battery modules through an internal cooling medium.

2. The device of claim 1, wherein the direct liquid cooling medium is further configured to absorb heat from the battery modules by directly contacting another portion of each of the battery modules, excluding a portion of each of the battery modules in which electrical elements are most densely concentrated.

3. The device of claim 2, wherein the electrical elements include at least one of a busbar configured to electrically connect the battery modules and a battery module tap.

4. The device of claim 1, further comprising a cooling passage configured to circulate the direct liquid cooling medium is,
wherein another portion of each of the battery modules and the heat transferrers are disposed in a cooling chamber.

5. The device of claim 1, wherein the direct liquid cooling medium is disposed in a closed space.

6. The device of claim 1, wherein the direct liquid cooling medium has electrical conductivity that is less than or equal to a threshold value required for electrosynthesis to occur.

7. The device of claim 1, wherein the heat transferrers are further configured to receive heat of the battery modules through the direct liquid cooling medium or absorb heat directly from the battery modules.

8. The device of claim 1, wherein each of the heat transferrers, serially disposed, has a different surface area in a flow direction of the direct liquid cooling medium.

9. The device of claim 8, wherein each subsequently disposed heat transferrer of the heat transferrers has a larger surface area than precedingly disposed heat transferrer in the flow direction of the direct liquid cooling medium.

10. The device of claim 8, wherein the heat transferrers are offsetly disposed in a rear portion of each of the battery modules in the flow direction of the direct liquid cooling medium.

11. The device of claim 1, wherein the heat transferrers have thicknesses determined based on a heat-generating property of the battery modules.

12. The device of claim 11, wherein the thicknesses of the heat transferrers corresponding to a most heat-generating portion of the battery modules are less than the thicknesses of the heat transferrers corresponding to other portions of the battery modules.

13. The device of claim 1, further comprising:
a cooling passage configured to come into contact with the heat transferrers and dissipate heat through an internal indirect liquid cooling medium.

14. The device of claim 1, wherein the heat transferrers include the internal cooling medium configured to absorb or dissipate heat through a phase change in a closed space.

15. The device of claim 1, wherein each of the heat transferrers is a heat pipe.

16. The device of claim 1, wherein the internal cooling medium is configured to transfer heat through a capillary or convection process in a closed space of each of the heat transferrers.

17. A battery device, comprising:
a battery pack including a plurality of battery modules;
a direct liquid cooling medium configured to directly contact and absorb heat from the battery modules; and
a plurality of heat transferrers, each respectively disposed between the battery modules, configured to absorb heat generated in a portion of each of the battery modules through an internal cooling medium.

18. The battery device of claim 17, wherein the direct liquid cooling medium is further configured to absorb heat from the battery modules by directly contacting another portion of each of the battery modules, excluding a portion of each of the battery modules in which electrical elements are most densely concentrated.

19. The battery device of claim 17, wherein the heat transferrers are further configured to absorb heat of the battery modules through the direct liquid cooling medium or directly from the battery modules.
